(19) United States
(12) Patent Application Publication
(10) Pub. No.: US 2009/0052608 A1
(43) Pub. Date: Feb. 26, 2009

(54) METHOD FOR DYNAMICALLY ADJUSTING HARDWARE EVENT COUNTING TIME-SLICE WINDOWS

(75) Inventor: John E. Attinella, Rochester, MN (US)

Correspondence Address: CANTOR COLBURN LLP - IBM ROCHESTER DIVISION, 20 Church Street, 22nd Floor, Hartford, CT, 06103, US

(73) Assignee: INTERNATIONAL BUSINESS MACHINES CORPORATION, Armonk, NY (US)

(21) Appl. No.: 11/842,290

(22) Filed: Aug. 21, 2007

(51) Int. Cl. G07C 3/00

(52) U.S. Cl. 377/15

(57) ABSTRACT

A method for dynamically adjusting a hardware event counting lime-slice window includes initializing a time-slice weight corresponding to a hardware event, initializing the hardware event counting time-slice window based on the time-slice weight and setting a performance monitoring unit (PMU) to monitor the hardware event with a value extracted from a performance monitoring counter (PMC) table. The PMU includes at least one control register and at least one performance monitoring counter (PMC) register, and the value corresponds to the hardware event. The method further includes counting occurrences of the hardware event until the time-slice window expires to provide a single pass count value, normalizing the single pass count value to provide a normalized single pass count value, calculating an adjusted time-slice weight using the normalized single pass count value and the time-slice weight, and storing the adjusted time-slice weight.

### TRADEMARKS

IBM® is a registered trademark of International Business Machines Corporation, Armonk, N.Y., U.S.A. Other names used herein may be registered trademarks, trademarks or product names of International Business Machines Corporation or other companies.

### BACKGROUND

1. Technical Field

This invention generally relates to hardware event counting. Specifically, this invention relates to dynamically adjusting hardware event counting time-slice windows.

2. Description of Background

Conventional computer systems may contain facilities to collect hardware metrics used for performance analysis. Typically, these facilities contain a set of control registers and a set of counter registers. The control registers may be configured to count a specific set of hardware events. Some examples of these hardware events may include number of instructions executed, types of instructions executed, cache hits, and cache misses.

On some computing platforms, there may be a large number of hardware events that can be configured for counting. However, there may be a limited number of actual registers for collecting these counts. Therefore, some computing platforms may employ a multiplexed counting system, where particular types of events are only counted for a brief period of an overall counting window.

For example, each event of the large number of events may be counted for ten milliseconds of the overall counting window. Afterwards, a projected number of events may be calculated using the fixed, ten millisecond counting window. If most events occur very frequently, an accurate number of events may be projected using this fixed-window approach. However, for less frequent events, the projection may be very inaccurate.

Furthermore, for many performance analysis activities it may be important to be able to more accurately record particular types of events, including less frequent events, such that the performance of different systems may be more accurately compared.

### SUMMARY

A method for dynamically adjusting a hardware event counting time-slice window includes initializing a time-slice weight corresponding to a hardware event, initializing the hardware event counting time-slice window based on the time-slice weight, and setting a performance monitoring unit (PMU) to monitor the hardware event with a value extracted from a performance monitoring counter (PMC) table. The PMU includes at least one control register and at least one performance monitoring counter (PMC) register, and the value corresponds to the hardware event. The method further includes setting the at least one control register using the value extracted from the PMC table, configuring the at least one PMC register to count occurrences of the hardware event using the control register, counting occurrences of the hardware event in the PMC register until the time-slice window expires to provide a single pass count value, normalizing the single pass count value with an average of single pass count values to provide a normalized single pass count value, calculating an adjusted time-slice weight using the normalized single pass count value and the time-slice weight, and storing the adjusted time-slice weight as the time-slice weight.

Additional features and advantages are realized through the techniques of the exemplary embodiments described herein. Other embodiments and aspects of the invention are described in detail herein and are considered a part of the claimed invention. For a better understanding of the invention with advantages and features, refer to the detailed description and to the drawings.

### BRIEF DESCRIPTION Of THE DRAWINGS

The subject matter which is regarded as the invention is particularly pointed out and distinctly claimed in the claims at the conclusion of the specification. The foregoing and other objects, features, and advantages of the invention are apparent from the following detailed description taken in conjunction with the accompanying drawings in which:

FIG. 1 illustrates a hardware event counting system, according to an exemplary embodiment; and

FIG. 2 illustrates a method for dynamically adjusting hardware event counting frequency, according to an exemplary embodiment.

The detailed description explains an exemplary embodiment, together with advantages and features, by way of example with reference to the drawings.

### DETAILED DESCRIPTION

According to an exemplary embodiment, a solution has been achieved which significantly increases the accuracy of projecting hardware event occurrences in a hardware event counting system. This increase in accuracy results in the ability to monitor hardware events, including less frequently occurring events, such that the performance of different systems may be more accurately compared.

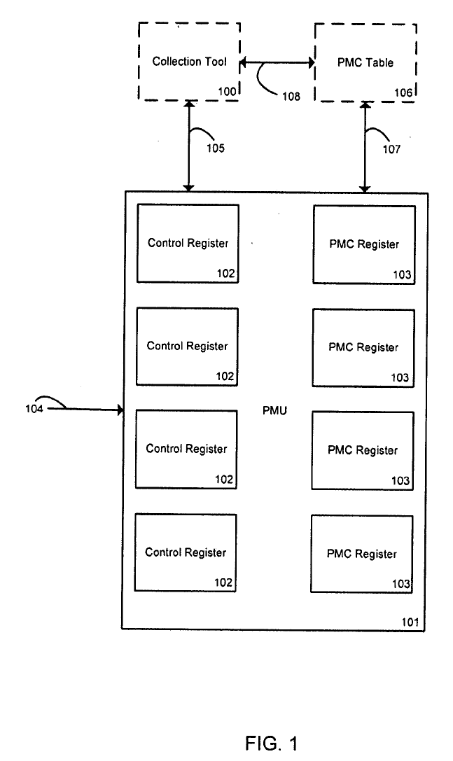

Different computing systems and operating environments may provide performance tools to configure collection of hardware event counts. Turning to FIG. 1, a hardware event counting system 110 is illustrated as having a collection tool 100 and a performance monitoring unit (PMU) 101. The system may allow communication of instructions from the collection tool 100 to the PMU 101 over channel 105, and vice versa. The instructions may include necessary information for collection and/or counting of hardware events. As used herein, hardware events include any event which may be monitored using the PMU 101. Such events may include cache hits, cache misses, and other suitable events.

The collection tool 100 is any available software tool which allows monitoring of hardware events. For example, the collection tool 100 may be a computer system benchmark program or other similar program specifically aimed at recording performance parameters (including hardware events) of a computer system.

The PMU 101 is computer hardware containing control registers 102 and performance monitor counter registers (PMC registers) 103. The control registers 102 may be set to cause the counting of specific hardware events within the PMC registers 103. In many systems, a plurality of different hardware events are available for counting, however a smaller number of PMC registers exist. Therefore, at any given lime, only the number of different hardware events equal to number of PMC registers may be counted. For example, as only four PMC registers are illustrated in FIG. 1, only four different hardware events may be counted simultaneously. However, it should be noted that any number of registers may be used without departing from the scope of exemplary embodiments. Therefore, systems employing more or less than four registers are equally applicable to exemplary embodiments.

Further illustrated in FIG. 1 is performance monitor counter table (PMC table) 106. PMC table 106 may include a plurality of rows and columns defining control register settings for different hardware events. According to an exemplary embodiment, each PMC table row defines the control register settings and associated text descriptions for programming the PMC registers to count a specific set of hardware events. In addition, the collection tool 100 may provide the ability to dynamically time-slice through each table row, and collect counts for every possible hardware event. Therefore, according to an exemplary embodiment, each set of counts for a particular hardware event are only counted for the time-slice window that a particular PMC table row is configured for. An exemplary PMC table is provided below as table 1, which includes only example data which should not be construed as limiting:

TABLE 1

| | Control | | |
|---|---|---|---|
| Row # | Register | Configured Event Description | Saved Time-Slice |
| (x) | Setting (CR) | (CED) | Weight (STSW) |
| 1 | 12345678 | Instructions completed | 1.00 |
| 2 | 23456789 | Conditional Branches | 1.00 |
| 3 | 34567890 | Data loaded from L3 cache | 1.00 |
| 4 | 45678901 | Data loaded from L2 cache | 1.00 |
| 5 | 56789012 | DISP unit held | 1.00 |
| 6 | 67890123 | L1 D cache load references | 1.00 |
| 7 | 78901234 | Instruction pre-fetch requests | 1.00 |
| 8 | 89012345 | TLB reference | 1.00 |

For example, if there are eight PMC table rows, and row number two counted twenty-thousand instructions in a given collection period, the projected count for events of row two would be one-hundred-sixty-thousand, assuming one-eighth of the collection period was used to count events for row two (i.e., a time-slice of one-eighth the collection period is used). However, according to an exemplary embodiment, all time-slices may not be exactly equal, thus an accumulated time value (AT) is also maintained for each row so that an accurate portion of overall time can be calculated. With this accumulated time value AT, the counters for each time-slice can be scaled with more precision by using this more accurate multiplication factor instead of assuming exactly equal time-slices.

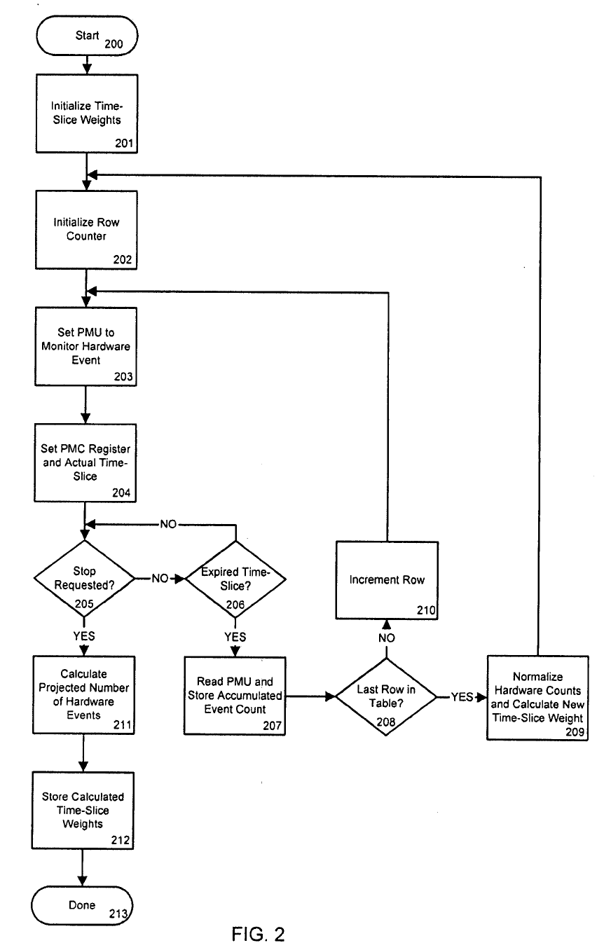

Further illustrated in FIG. 1 is channel 104. Channel 104 provides the PMU 101 with hardware events from a system connected to channel 104. For example, system 110 may be included in a computer system and channel 104 may be a channel in communication with different hardware portions in the computer system. If a hardware portion provides a hardware event, and PMU 101 is configured (e.g., through control registers 102) to monitor the hardware event, the event may be counted in PMC registers 103. Depending upon the frequency of the hardware events provided to PMU 101, PMC registers may count the hardware events at scaled time intervals (i.e., different time-slices for different hardware events are scaled based on frequency of occurrence). Hereinafter, scaling of time-slices will be described in more detail with reference to FIG. 2.

All hardware events are not necessarily equivalent in that some hardware events occur much less frequently than other hardware events. Also, some hardware events occur much more frequently than others. Fixed time-slice employment (e.g., all time-slices are equal within a collection period) is accurate only if there are a sufficient number of events counted over the workload being measured. More clearly, there has to be a large enough number of events sampled in the collection period to retain statistical accuracy of projected values if fixed time-slice windows are used. If, however, there are only a few events recorded in one time-slice, the accuracy of scaling the resulting number based on the fraction of accumulated time in the time-slice can be quite low.

For example, a given workload has event “A” occurring five-hundred-thousand times and event “B” occurring two-hundred times, and a PMC table has one-hundred rows. In fixed time-slice employment, every time-slice would be 1/100 of the total collection period. In a perfect statistical period, the counter of event A would count five-thousand events and the counter of event B would count two events. However, consider that the 1/100 window of time for event B did not occur when event B actually occurred (statistically this is very possible). Because event B is a rare event, it is likely that only one event is counted during the fixed 1/100 fraction of the total collection period. This example would provide a projected count of one-event times one-hundred slices (i.e., one-hundred events instead of the actual two-hundred events, or about 100% error). If the collection period ran sufficiently long, the amount of error would eventually be reduced. However, the collection period for counting more events would become exceedingly larger as the number of events counted increases. Therefore, according to an exemplary embodiment, a method of dynamically adjusting hardware event counting frequency (i.e., time-slices) is provided.

Turning to FIG. 2, the method 220 begins at block 200. For example, a collection tool substantially similar to that illustrated in FIG. 1 may provide a starting command or other instruction to begin hardware event counting by a hardware event counting system. Thereafter, time-slices for the method 220 may be initialized at block 201.

As used hereinafter, time-slices are used to describe any portion or fraction of a collection period for counting hardware events. Because time-slices represent a real amount of time, they are proportional to the frequency of event counting. The time-slices may be initialized to stored values, for example, values stored for particular types of events to be counted in the collection period. As described above, a table format may be used to store performance monitoring values. If the table has x-rows, then for each row from zero to x, the time-slice weight to be used for counting (CTSWₓ) may be initialized to the time-slice weight stored in that row (STSWₓ). Such may be implemented by an equation similar to equation 1 below:

for each row #=x, set CTSWₓ=STSWₓ Equation 1

Subsequent to initializing each time-slice weights a row counter may be initialized in block 202. If the collection period is beginning at row zero, the row counter (x′) is initialized to zero. Such may be implemented by an equation similar to equation 2 below:

set current row #, x′=0 Equation 2

However, it is noted that any row of a PMC table may be used for initialization. Subsequent to initializing the row counter, a PMU may be set to monitor a particular set of hardware events in block 203. As described above, a PMU according to exemplary embodiments may contain a plurality of control registers. Each control register may direct a control register setting (CR) value of the PMC table to cause a specific event to be counted in PMC registers of the PMU. In an example where the PMU contains one control register and one PMC register, an equation such as equation 3 below may be used to implement this:

set PMU control register with value CRₓ Equation 3

Subsequent to initializing the PMU, the PMC register(s) and actual time-slice may be set to count a particular event (or alternatively, if there are multiple PMC registers, each may be set to count different events). For example, because weights of time-slices have been initialized in step 201, the actual time-slice being used (TS) within a timer may be set to a real value factoring in the time-slice weight for a particular event. Such may be implemented by an equation similar to equation 4 below:

set time-slice timer to TS*CTSW_{x′} Equation 4

Subsequently, a loop is included with decision blocks 205 and 206 to enable the PMU to monitor hardware event counts for the duration of the time-slice (or similarly referred to as the time-slice window). If the time-slice expires, the loop is broken and the PMC register for the particular event being counted is accessed to reveal a single pass counter value (SPCV) for accumulation. An accumulated counter value (ACV) may be used to store accumulated values for each pass of the loop. The ACV may be added to the most recent SPCV for the particular event to keep track of all events counted in a collection period. Such may be implemented using equations similar to equations 5 and 6 below:

set SPCV_{x′} to PMC register value Equation 5

add SPCV_{x′} to ACV_{x′} Equation 6

Thereafter, method 220 may include checking if the last row of the PMC table has been accessed (i.e., last row's stored event(s) have been counted) in decision block 208. If the last row has not been accessed, the row counter is incremented in block 210 and the PMU is set to monitor the new row's stored event(s) in block 203. If the last row has been accessed, counts are normalized and a new time-slice weight is calculated in block 209. For example, such may be implemented by an equation similar to equation 7 below:

for each row #=x, set CTSWₓ=CTSWₓ*Average[SPCV]/SPCVₓ Equation 7

As shown by equation 7, depending upon the number of events counted for a time-slice (i.e., frequency of occurrence), a new weight for the row may be calculated taking into consideration the frequency of occurrence. Therefore, according to an exemplary embodiment, method 220 includes dynamically adjusting the frequency at which hardware events are counted, based upon the frequency at which they occur (i.e., dynamically adjusting a time-slice window to more accurately project hardware event counts). As shown by method 220, this includes both increasing the time-slice window for infrequent events, and decreasing the time-slice window for more frequent events. After the new time-slice weight is calculated in block 209, the row counter is initialized again in block 202.

Turning back to the loop formed by decision blocks 205 and 206, if a time-slice has not expired, but a stop has been requested (i.e., by the collection tool or other suitable means), the loop is also broken and the collection period ends. If the loop is broken because of a requested stop, the projected number of hardware event counts (PC) is calculated in block 211. Because an accumulated time (AT) may be calculated for a row, it may be used alongside the ACV for the row to project the actual number of events occurring during the collection period. The AT represents the total time that is allocated for a particular row. For example, this includes all the time-slice times that have accumulated during the collection period. This result may be calculated and multiplied by the ACV to project the number of events that have actually occurred. Such may be implemented by an equation similar to equation 8 below:

for each row #=x, PCₓ=ACVₓ*Sum[AT]/ATₓ Equation 8

Thereafter, the time-slice weights that have been calculated may be stored for future use in block 212. More clearly, the CTSW for each separate row may be stored as the STSW for each row, thereby enabling more accurate counting for each subsequent collection period. It is noted that this feature, in combination with dynamic adjustment of time-slice windows, provides the added benefit of a dramatic increase in the statistical quality of the projected information, thereby allowing for more accurate comparison of the performance parameters for different systems.

Therefore, according to an exemplary embodiment, a weighted adaptive hardware event counter time-slicing facility is provided that dynamically adjusts the duration of each time-slice based on the frequency of occurrence of the configured hardware event for each time-slice, thus improving the statistical quality of the resulting data for a given collection period. This information, may be retained across a plurality of collection periods such that subsequent collections benefit from the previously learned behaviors. Also, the total count of hardware events is projected by extrapolating the resulting row counts using accumulated time values for each row. Therefore, using implementations of the exemplary embodiment of the present invention will provide more accurate hardware event counter data in a shorter collection period than previously possible.

The present invention may be implemented, in software, for example, as any suitable computer program. For example, a program in accordance with the present invention may be a computer program product causing a computer to execute the example method described herein: a method for dynamically adjusting a hardware event counting time-slice window.

The computer program product may include a computer-readable medium having computer program logic or code portions embodied thereon for enabling a processor of a computer apparatus to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body. Examples of the built-in medium include, but are not limited to, rewritable non-volatile memories, such as RAMs, ROMs, flash memories, and hard disks. Examples of a removable medium may include, but are not limited to, optical storage media such as CD-ROMs and DVDs; magneto-optical storage media such as MOs; magnetism storage media such as floppy disks (trademark), cassette tapes, and removable hard disks; media with a built-in rewritable non-volatile memory such as memory cards; and media with a built-in ROM, such as ROM cassettes.

Further, such programs, when recorded on computer-readable storage media, may be readily stored and distributed. The storage medium, as it is read by a computer, may enable the method for dynamically adjusting a hardware event counting time-slice window, in accordance with an exemplary embodiment of the present invention.

While an exemplary embodiment has been described, it will be understood that those skilled in the art, both now and in the future, may make various improvements and enhancements which fall within the scope of the claims which follow. These claims should be construed to maintain the proper protection for the invention first described.

What is claimed is:

1. A method for dynamically adjusting a hardware event counting time-slice window, comprising:
initializing a time-slice weight corresponding to a hardware event;
initializing the hardware event counting time-slice window based on the time-slice weight;
setting a performance monitoring unit (PMU) to monitor the hardware event with a value extracted from a performance monitoring counter (PMC) table, wherein the PMU includes at least one control register and at least one performance monitoring counter (PMC) register, and the value corresponds to the hardware event;
setting the at least one control register using the value extracted from the PMC table;
configuring the at least one PMC register to count occurrences of the hardware event using the control register;
counting occurrences of the hardware event in the PMC register until the time-slice window expires to provide a single pass count value;
normalizing the single pass count value with an average of single pass count values to provide a normalized single pass count value;
calculating an adjusted time-slice weight using the normalized single pass count value and the time-slice weight; and
storing the adjusted time-slice weight as the time-slice weight.

2. The method of claim 1, wherein:
the initializing the time-slice weight includes initializing a plurality of time-slice weights corresponding to a plurality of hardware events; and
the initializing the hardware event counting time-slice window includes initializing a plurality of time-slice windows based on the plurality of time-slice weights.

3. The method of claim 2, wherein:
the PMU further includes a plurality of control registers and a plurality of PMC registers;
the PMU is set using a plurality of values extracted from the PMC table;
the plurality of control registers are set using the plurality of values extracted from the PMC table; and
the plurality of PMC registers are configured to count occurrences of the plurality of hardware events using the plurality of control registers.

4. The method of claim 1, further comprising:
accumulating an accumulated value of hardware event occurrences using the single pass count value and the accumulated value; and
storing the accumulated value.

5. The method of claim 4, further comprising:
calculating an accumulation time, wherein the accumulation time includes all time-slice window values for the hardware event; and
calculating a projected number of hardware events using the accumulated value and the accumulation time.

6. A hardware event counting system configured to perform the method according to claim 1.

7. A computer-readable medium including computer instructions that, when executed on a host processor of a computer apparatus, directs the host processor to perform a method for dynamically adjusting a hardware event counting time-slice window, the method comprising:
initializing a time-slice weight corresponding to a hardware event of the computer apparatus;
initializing the hardware event counting time-slice window based on the time-slice weight;
setting a performance monitoring unit (PMU) to monitor the hardware event with a value extracted from a performance monitoring counter (PMC) table, wherein the PMU includes at least one control register and at least one performance monitoring counter (PMC) register, and the value corresponds to the hardware event;
setting the at least one control register using the value extracted from the PMC table;
configuring the at least one PMC register to count occurrences of the hardware event using the control register;
counting occurrences of the hardware event in the PMC register until the time-slice window expires to provide a single pass count value;
normalizing the single pass count value with an average of single pass count values to provide a normalized single pass count value:
calculating an adjusted time-slice weight using the normalized single pass count value and the time-slice weight; and
storing the adjusted time-slice weight as the time-slice weight.
